(19) United States
(12) Patent Application Publication
(10) Pub. No.: US 2024/0279759 A1
(43) Pub. Date: Aug. 22, 2024

(54) HYDROGEN GAS RECYCLING IN A DIRECT REDUCTION PROCESS

(71) Applicant: HYBRIT Development AB, Stockholm (SE)

(72) Inventors: Raimon Perea Marin, Handen (SE); Farzad Mohseni-Mörner, Spånga (SE); Javad Fayazi, Solna (SE)

(21) Appl. No.: 18/571,210

(22) PCT Filed: Jun. 20, 2022
(86) PCT No.: PCT/SE2022/050607

§ 371 Date: Dec. 15, 2023

(30) Foreign Application Priority Data
Jun. 22, 2021 (SE) 2150805-6

(51) Int. Cl. C21B 13/00

(52) U.S. Cl. CPC C21B 13/0073; C21B 2100/284; C21B 2100/40

(57) ABSTRACT

A system for the production of sponge iron, the system including a direct reduction shaft including a first inlet for introduction of iron ore into the shaft, a first outlet for removing sponge iron from the shaft, a reduction gas source, connected through a gas line with the shaft, a first compressor in said gas line, and a primary circuit for conducting at least a part of the top gas therethrough. The primary circuit is connected in one end with shaft and in another end with said gas line downstream said first compressor. The system also includes a secondary circuit for conducting at least a portion of gas removed from gas conducted through the primary circuit, said secondary circuit being connected in one end to the primary circuit and in another end to said gas line upstream said first compressor. The system further includes means therein for reducing the pressure of said portion of gas conducted through the secondary circuit, and a first valve for controlling a flow of said portion of gas into the secondary circuit.

### TECHNICAL FIELD

The present disclosure relates to a process for the production of sponge iron from iron ore. The disclosure further relates to a system for the production of sponge iron.

### BACKGROUND ART

Steel is the world's most important engineering and construction material. It is difficult to find any object in the modern world that does not contain steel, or depend on steel for its manufacture and/or transport. In this manner, steel is intricately involved in almost every aspect of our modern lives.

In 2018, the total global production of crude steel was 1 810 million tonnes, by far exceeding any other metal, and is expected to reach 2 800 million tonnes in 2050 of which 50% is expected to originate from virgin iron sources. Steel is also the world's most recycled material with a very high recycling grade due to the metals' ability to be used over and over again after remelting, using electricity as the primary energy source.

Thus, steel is a cornerstone of modern society with an even more significant role to play in the future.

Steel is mainly produced via three routes:
i) Integrated production using virgin iron ores in a blast furnace (BF), where iron oxide in the ore is reduced by carbon to produce iron. The iron is further processed in the steel plant by oxygen blowing in a basic oxygen furnace (BOF), followed by refining to produce steel. This process is commonly also referred to as ‘oxygen steelmaking’.
ii) Scrap-based production using recycled steel, which is melted in an electric arc furnace (EAF) using electricity as the primary source of energy. This process is commonly also referred to as ‘electric steelmaking’.
iii) Direct reduction production based on virgin iron ore, which is reduced in a direct reduction (DR) process with a carbonaceous reduction gas to produce sponge iron. The sponge iron is subsequently melted together with scrap in an EAF to produce steel.

The term crude iron is used herein to denote all irons produced for further processing to steel, regardless of whether they are obtained from a blast furnace (i.e., pig iron), or a direct reduction shaft (i.e. sponge iron).

Although the above-named processes have been refined over decades and are approaching the theoretical minimum energy consumption, there is one fundamental issue not yet resolved. Reduction of iron ore using carbonaceous reductants results in the production of CO₂ as a by-product. For every ton steel produced in 2018, an average of 1.83 tonnes of CO₂ were produced. The steel industry is one of the highest CO₂-emitting industries, accounting for approximately 7% of CO₂emissions globally. Excessive CO₂-generation cannot be avoided within the steel production process as long as carbonaceous reductants are used.

The HYBRIT initiative has been founded to address this issue. HYBRIT, short for HYdrogen BReakthrough Ironmaking Technology—is a joint venture between SSAB, LKAB and Vattenfall, funded in part by the Swedish Energy Agency, and aims to reduce CO₂emissions and de-carbonize the steel industry.

Central to the HYBRIT concept is a direct reduction-based production of sponge iron from virgin iron ore. However, instead of using carbonaceous reductant gases, such as natural gas, as in present commercial direct reduction processes, HYBRIT proposes using hydrogen gas as the reductant, termed hydrogen direct reduction (H-DR). The hydrogen gas may be produced by electrolysis of water using mainly fossil-free and/or renewable primary energy sources, as is the case for e.g., Swedish electricity production. Thus, the critical step of reducing the iron ore may be achieved without requiring fossil fuel as an input, and with water as a by-product instead of CO₂.

Prior art uses reduction gas which to a large degree consists of natural gas. A direct reduction plant normally comprises a shaft in which the reduction takes place. The shaft has an inlet at the top, where iron ore pellets are introduced and an outlet at the bottom, where sponge iron is removed from shaft. There is also at least one inlet at a lower part of the shaft for introduction of a reduction gas into the shaft, and at least one outlet at an upper part of the shaft for the exit of a top gas. A large part of the top gas will consist of unreacted reduction gas, possibly mixed up with inert gas used for the sealing of the inlets and outlets for the iron ore pellets and the sponge iron respectively. A conventional way of handling the top gas is by flaring the latter.

However, when predominantly or only using hydrogen as a reduction gas, flaring is a less attractive option from an energy efficiency point of view, since, compared to natural gas, the production of hydrogen gas requires substantial amounts of energy. Furthermore, if the top gas comprises nitrogen gas (normally used as a sealing gas), the flaring will also result in the emission of NOx, which is not preferred from an environmental point of view.

It is therefore an object of the present invention to present a process and a system for the direct reduction of iron ore to sponge iron that predominantly or exclusively uses hydrogen gas as the reduction gas, wherein there is provided means for efficient recycling of unreacted hydrogen gas exiting a direct reduction shaft as part of a top gas.

### SUMMARY OF THE INVENTION

The object of the invention is achieved by means of a process for the production of sponge iron from iron ore, the process comprising the steps:
charging iron ore into a direct reduction shaft;
introducing a hydrogen-rich reduction gas from a reduction gas source into the direct reduction shaft in order to reduce the iron ore and produce sponge iron;
removing a top gas from the direct reduction shaft, said top gas comprising unreacted hydrogen gas;
conducting in a primary circuit at least a part of the removed top gas and mixing said part with reduction gas from the reduction gas source at a point downstream a first compressor provided in a gas line leading from the reduction gas source to the direct reduction shaft, and introducing the mixture into the direct reduction shaft;
removing from said primary circuit a portion of the gas conducted therein, and conducting said portion of gas through a secondary circuit while reducing the pressure of said portion of gas, and mixing said portion of gas with reduction gas from the reduction gas source at a point in said gas line upstream said first compressor.

Removal of the portion of gas into the secondary circuit is normally performed as a response to the pressure in the primary circuit being above a predetermined level. The hydrogen is not lost or wasted as e.g., heating fuel, and instead a majority of the bled-off hydrogen is recovered and reutilized as reduction gas. This decreases the operating costs of such a process. Moreover, since the majority of the bled-off hydrogen is no longer burned, the risk of excessive NOx emission is significantly diminished or avoided altogether. In other words, the secondary circuit will enable control of the pressure in the primary circuit without flaring excessive top gas containing expensive hydrogen gas from the system. The secondary circuit will function as a buffer, and will make it possible to decrease the amount of reduction gas conducted from the reduction gas source into the gas line. According to one embodiment, under dry conditions, the reduction gas introduced into the direct reduction shaft comprises more than 70 vol. % hydrogen. According to one embodiment the reduction gas introduced into the shaft comprises more than 80 vol. % hydrogen, and according to another embodiment, it comprises more than 90 vol. % hydrogen.

If, during operation, the amount of top gas increases, and the pressure in the primary circuit thereby increases, excessive hydrogen gas in the primary circuit will be removed into the secondary circuit. Accordingly, the pressure in the primary is controlled such that it will not be too high with regard to the pressure downstream the first compressor. Since excessive hydrogen gas in the primary circuit is thus conducted back to the reduction gas line through the secondary circuit, venting or flaring of excessive hydrogen gas in the primary circuit may be prevented. The reduction of the pressure in the secondary circuit is, preferably, achieved by means of a suitable valve, such as an expansion valve or a pressure reducer. If a pressure reducer is applied, electric power is preferably generated from the motion of the pressure reducer, and preferably used for the production of hydrogen gas.

According to one embodiment, said first compressor is a final compressor stage in said gas line, bringing the pressure in of the reduction gas from the reduction gas source in the gas line to its final pressure before entering the direction reduction shaft.

According to one embodiment, a gas flow rate through the gas line and into the direct reduction shaft is measured, and a flow of reduction gas from the reduction gas source into the gas line is controlled on basis of the gas flow rate measured in the gas line. The total flow rate of reduction gas through the gas line and into the direct reduction shaft is dependent on the amount of iron ore being introduced into and present in the shaft. If the reduction gas flow rate is too low, complete reduction of the iron ore in the direct reduction shaft will not be achieved, and the temperature in the shaft will go down. If the flow rate is too high, an excessive pressure will appear in the direct reduction shaft. According to one embodiment, the temperature in the shaft is measured and the direct reduction gas flow rate into the shaft (comprising gas from the primary circuit, the secondary circuit and from the reduction gas source) is controlled on basis thereof. According to one embodiment, the pressure in the direction reduction shaft, or in the primary circuit, is measured and the reduction gas flow rate into the direct reduction shaft is controlled on basis thereof. According to one embodiment, the reduction gas source comprises at least one electrolyser for production of hydrogen gas. According to one embodiment, the output of the electrolyser is controlled as a means for controlling the reduction gas flow rate on basis of temperature and pressure in the direct reduction shaft.

According to one embodiment, the removal of said portion of gas from the primary circuit to the secondary circuit is dependent on the gas pressure in the primary circuit.

According to one embodiment, the process further comprises the steps of measuring the gas pressure in the primary circuit and conducting said portion of gas into the secondary circuit from the primary circuit as a response to the measured pressure being at or above a predetermined first level. A pressure sensor, a controllable valve and a control a control unit for controlling the controllable valve on basis of information from the pressure sensor will thus be used. In an alternative embodiment, a relief valve is used for bleeding off said portion of top gas into the secondary circuit as a response to the pressure in the primary circuit being above the predetermined first level. There may also be provided for a permanent bleed-off of top gas into the secondary circuit irrespectively of the pressure in the primary circuit.

According to one embodiment, the pressure in the primary circuit is regulated by means of removal of said portion of gas to the secondary circuit, in order not to exceed said predetermined first level. As soon as the pressure level reaches said predetermined level, a control valve by means of which the flow of gas from the primary circuit into the secondary circuit is controlled is opened to such a degree that the pressure is prevented in the primary circuit is prevented from increasing further.

According to one embodiment, the primary circuit comprises a second compressor provided downstream a point along the primary circuit at which said portion of gas is removed to the secondary circuit, and said measurement of the gas pressure is performed upstream said second compressor. The second compressor is needed in order to increase the gas pressure to a level which is above the level downstream the first compressor, in order to enable the gas in the primary circuit to flow into and get mixed with the reduction gas in said gas line.

According to one embodiment, the gas pressure in the secondary circuit is reduced to a predetermined second level, which is above a gas pressure level in said gas line upstream said first compressor. The predetermined second level should be slightly higher than the pressure in the gas line upstream the first compressor. An expansion valve or a pressure reducer may be used for the pressure reduction in the secondary circuit. According to one embodiment, said means is a pressure reducer and the pressure reducer comprises a turbine and means for transforming the generated motion of the turbine into electric power. There may be provided a vent valve in the secondary circuit for the purpose of further need of reducing the pressure in the secondary circuit. According to one embodiment, such a vent valve is provided upstream an expansion valve or pressure reducer used for reducing the pressure, and upstream a control valve that controls the flow of gas from the primary circuit into the secondary circuit. The vent valve may be a relief valve or an operable valve controlled by the control unit.

According to one embodiment, the top gas is subjected to a gas treatment step at a point along the first primary circuit between a point where the top gas is removed from the direct reduction shaft and the point at which said portion of gas is conducted into the secondary circuit

According to one embodiment, said treatment step comprises separation of an inert gas from said part of the top gas that is to be conducted through the primary circuit. A separation unit used for the separation may be a cryogenic separation unit, a membrane separation unit, a pressure-swing absorption unit, or an amine CO₂ scrubber. A number of well-established gas separation means may be suitable for separating hydrogen from the inert gas (e.g., nitrogen and/or carbon dioxide). For example, due to the large difference in boiling points between nitrogen (−195.8° C.) and hydrogen (−252.9° C.), cryogenic separation may be suitable.

According to one embodiment, said treatment step comprises separating water from said part of the top gas that is to be conducted through the primary circuit. Preferably, the treatment step also comprises removal of dust from the top gas.

According to one embodiment, said treatment step comprises reducing the temperature of the top gas in a heat exchanger and using said heat from the top gas for heating another gas to be used in said process.

According to one embodiment, said other gas is reduction gas which is to be introduced into the direct reduction shaft via said gas line.

The object of the invention is also achieved by means of a system for the production of sponge iron, the system comprising:
a direct reduction shaft comprising
   a first inlet for introduction of iron ore into the shaft;
   a first outlet for removal of sponge iron from the shaft;
   a second inlet for introduction of a reduction gas into the shaft, and
   a second outlet for removal of top gas from the shaft;
a reduction gas source, connected through a gas line with the reduction gas inlet;
a first compressor provided in said gas line;
a primary circuit for conducting at least a part of the top gas through it, said primary circuit being connected in one end with the second outlet and in another end with said gas line downstream said first compressor,
a secondary circuit for conducting at least a portion of gas removed from gas conducted through the primary circuit, said secondary circuit being connected in one end to the primary circuit and in another end to said gas line upstream said first compressor, and comprising means therein for reducing the pressure of said portion of gas conducted through the secondary circuit, and
a first valve for controlling a flow of said portion of gas into the secondary circuit.

According to one embodiment, the means for reducing the pressure comprises an expansion valve or a pressure reducer. According to one embodiment, said means is a pressure reducer and the pressure reducer comprises a turbine and means for transforming the generated motion of the turbine into electric power.

According to one embodiment, the system comprises a control arrangement for controlling a flow of reduction gas from the reduction gas source into the gas line on basis of the gas flow rate in the gas line. The measured gas flow rate in the gas line is the sum of the reduction gas from the reduction gas source (also possible referred to a make-up gas), and the gas from the primary and secondary circuits added thereto. The measurement may therefore consist of a single measurement downstream the point at which the primary circuit is connected to the gas line, or a combination of gas flow measurements in the gas line, the primary circuit and the secondary circuit.

According to one embodiment, said control arrangement comprises a second valve for controlling a flow of reduction gas from the reduction gas source into the gas line, a gas flow rate meter for measuring a flow of gas through the gas line, and a control unit, which is configured to control said second valve on basis of input from the gas flow rate meter.

According to one embodiment, said first valve is configured to open for passage of gas into the secondary circuit as a response to the gas pressure in the primary circuit being above a predetermined level.

According to one embodiment, said first valve is a controllable valve, and the system further comprises a pressure sensor arranged in the primary circuit and a control unit configured to control said controllable first valve on basis of input received from the pressure sensor.

According to one embodiment, the primary circuit comprises a second compressor provided downstream a point along the primary circuit at which the secondary circuit is connected to the primary circuit, and wherein the pressure sensor is positioned upstream said second compressor.

According to one embodiment, the primary circuit comprises a device for treatment of the top gas, said device comprising a device for separation of an inert gas from said part of the top gas that is to be conducted through the primary circuit.

According to one embodiment, the primary circuit comprises a device for treatment of the top gas, said device comprising a device for separation of water from said part of the top gas that is to be conducted through the primary circuit. The device for treatment of the top gas preferably also comprises a device for removal of top gas from the top gas.

According to one embodiment, the primary circuit comprises a device for treatment of the top gas, said device comprising a heat exchanger.

According to one embodiment, the heat exchanger is also connected to said gas line and configured to transfer heat from the top gas to the reduction gas to be introduced into the direct reduction shaft.

According to one embodiment, the reduction gas source comprises a water electrolyser unit.

Further objects, advantages and novel features of the present invention will become apparent to one skilled in the art from the following detailed description.

### BRIEF DESCRIPTION OF THE DRAWINGS

For a fuller understanding of the present invention and further objects and advantages of it, the detailed description set out below should be read together with the accompanying drawings, in which the same reference notations denote similar items in the various diagrams, and in which:

FIG. 1 schematically illustrates an iron ore-based steelmaking value chain according to the Hybrit concept and;

FIG. 2 schematically illustrates an exemplifying embodiment of a system suitable for performing a process as disclosed herein.

### DETAILED DESCRIPTION

### Definitions

Reduction gas is a gas capable of reducing iron ore to metallic iron. The reducing components in conventional direct reduction processes are typically hydrogen and carbon monoxide, but in the presently disclosed process, the reducing component is predominantly or exclusively hydrogen. The reduction gas is introduced at a point lower than the iron ore inlet of the direct reduction shaft, and flows upwards counter to the moving bed of iron ore in order to reduce the ore.

Top gas is process gas that is removed from an upper end of the direct reduction shaft, in proximity to the ore inlet. The top gas typically comprises a mixture of partially spent reduction gas, including oxidation products of the reducing component (e.g. H2O), and inert components introduced to the process gas as e.g. seal gal. After treatment, the top gas may be recycled back to the direct reduction shaft as a component of the reduction gas.

A bleed-off stream removed from spent carburization gas in order to prevent accumulation of inert components in the carburization process gas is termed the carburization bleed-off stream.

Gas from the reduction gas source may be referred to as make-up gas. In the context of this application make-up gas is added to recycled top gas prior to re-introduction into the direct reduction shaft. Thus, the reduction gas typically comprises make-up gas together with recycled top gas.

Seal gas is gas entering the direct reduction shaft from the ore charging arrangement at the inlet of the direct reduction (DR) shaft. The outlet end of the direct reduction shaft may also be sealed using a seal gas, and seal gas therefore may enter the DR shaft from a discharging arrangement at the outlet of the direct reduction shaft. The seal gas is typically an inert gas in order to avoid explosive gas mixtures being formed at the shaft inlet and outlet. Inert gas is gas that does not form potentially flammable or explosive mixtures with either air or process gas, i.e. a gas that may not act as an oxidant or fuel in a combustion reaction under the conditions prevailing in the process. The seal gas may consist essentially of nitrogen and/or carbon dioxide. Note that although carbon dioxide is termed herein as an inert gas, it may under conditions prevailing in the system react with hydrogen in a water-gas shift reaction to provide carbon monoxide and steam.

### Reduction

The direct reduction shaft may be of any kind commonly known in the art. By shaft, it is meant a solid-gas counter current moving bed reactor, whereby a burden of iron ore is introduced at an inlet at the top of the reactor and descends by gravity towards an outlet arranged at the bottom of the reactor. Reduction gas is introduced at a point lower than the inlet of the reactor and flows upwards counter to the moving bed of ore in order to reduce the ore to metallized iron. Reduction is typically performed at temperatures of from about 900° C. to about 1100° C. The temperatures required are typically maintained by pre-heating of the process gases introduced into the reactor, for example using a preheater such as an electric preheater. Further heating of the gases may be obtained after leaving the pre-heater and prior to introduction into the reactor by exothermic partial oxidation of the gases with oxygen or air. Reduction may be performed at a pressure of from about 1 bar to about 10 bar in the DR shaft, preferably from about 3 bar to about 8 bar. The reactor may have a cooling and discharge cone arranged at the bottom to allow the sponge iron to cool prior to discharge from the outlet.

The iron ore burden typically consists predominantly of iron ore pellets, although some lump iron ore may also be introduced. The iron ore pellets typically comprise mostly hematite, together with further additives or impurities such as gangue, fluxes and binders. However, the pellets may comprise some other metals and other ores such as magnetite. Iron ore pellets specified for direct reduction processes are commercially available, and such pellets may be used in the present process. Alternatively, the pellets may be specially adapted for a hydrogen-rich reduction step, as in the present process.

The reduction gas is hydrogen-rich. By reduction gas it is meant the sum of fresh make-up gas plus recycled parts of the top gas being introduced into the direct reduction shaft. By hydrogen-rich it is meant that the reduction gas entering the direct reduction shaft may consist of greater than 70 vol % hydrogen gas, such as greater than 80 vol % hydrogen gas, or greater than 90 vol % hydrogen gas (vol % determined at normal conditions of 1 atm and 0° C.). Preferably, the reduction is performed as a discrete stage. That is to say that carburization is not performed at all, or if carburization is to be performed, it is performed separately from reduction, i.e. in a separate reactor, or in a separate discrete zone of the direct reduction shaft. This considerably simplifies treatment of the top gas, since it is avoids the need to remove carbonaceous components, and the expense associated with such removal. In such a case, the make-up gas may consist essentially of, or consist of, hydrogen gas. Note that some quantities of carbon-containing gases may be present in the reduction gas, even if the make-up gas is exclusively hydrogen. For example, if the sponge iron outlet of the direct reduction shaft is coupled to the inlet of a carburization reactor, relatively small quantities of carbon-containing gases may inadvertently permeate into the direct reduction shaft from the carburization reactor. As another example, carbonates present in the iron ore pellets may be volatilized and manifest as CO₂ in the top gas of the DR shaft, resulting in quantities of CO₂ that may be recycled back to the DR shaft. Due to the predominance of hydrogen gas in the reduction gas circuit, any CO₂ present may be converted by reverse water-gas shift reaction to CO.

In some cases it may be desirable to obtain some degree of carburization in conjunction with performing the reduction, as a single stage. In such a case, the reduction gas may comprise up to about 30 vol % of carbon-containing gases, such as up to about 20 vol %, or up to about 10 vol % (determined at normal conditions of 1 atm and 0° C.). Suitable carbon-containing gases are disclosed below as carburizing gases.

The hydrogen gas may preferably be obtained at least in part by electrolysis of water. If the water electrolysis is performed using renewable energy then this allows the provision of a reduction gas from renewable sources. The electrolytic hydrogen may be conveyed by a conduit directly from the electrolyser to the DR shaft, or the hydrogen may be stored upon production and conveyed to the DR shaft as required.

The top gas upon exiting the direct reduction shaft will typically comprise unreacted hydrogen, water (the oxidation product of hydrogen), and inert gases. If carburization is performed together with reduction, the top gas may also comprise some carbonaceous components such as methane, carbon monoxide and carbon dioxide. The top gas upon exiting the direct reduction shaft may initially be subjected to conditioning, such as dedusting to remove entrained solids, and/or heat exchange to cool the top gas and heat the reduction gas. During heat exchange, water may be condensed from the top gas. Preferably, the top gas at this stage will consist essentially of hydrogen, inert gas and residual water. However, if carbonaceous components are present in the top gas, such carbonaceous components may also be removed from the top gas, for example by reforming and/or CO₂ absorption.

### Sponge Iron

The sponge iron product of the process described herein is typically referred to as direct reduced iron (DRI). Depending on the process parameters, it may be provided as hot (HDRI) or cold (CDRI). Cold DRI may also be known as Type (B) DRI. DRI may be prone to re-oxidation and in some cases is pyrophoric. However, there are a number of known means of passivating the DRI. One such passivating means commonly used to facilitate overseas transport of the product is to press the hot DRI into briquettes. Such briquettes are commonly termed hot briquetted iron (HBI), and may also be known as type (A) DRI.

The sponge iron product obtained by the process herein may be an essentially fully metallized sponge iron, i.e. a sponge iron having a degree of reduction (DoR) greater than about 90%, such as greater than about 94% or greater than about 96%. Degree of reduction is defined as the amount of oxygen removed from the iron oxide, expressed as a percentage of the initial amount of oxygen present in the iron oxide. It is often not commercially favourable to obtain sponge irons having a DoR greater than about 96% due to reaction kinetics, although such sponge irons may be produced if desired.

If carburization is performed, sponge iron having any desired carbon content may be produced by the process described herein, from about 0 to about 7 percent by weight. However, it is typically desirable for further processing that the sponge iron has a carbon content of from about 0.5 to about 5 percent carbon by weight, preferably from about 1 to about 4 percent by weight, such as about 3 percent by weight, although this may depend on the ratio of sponge iron to scrap used in a subsequent EAF processing step.

### Embodiments

The invention will now be described in more detail with reference to certain exemplifying embodiments and the drawings. However, the invention is not limited to the exemplifying embodiments discussed herein and/or shown in the drawings, but may be varied within the scope of the appended claims. Furthermore, the drawings shall not be considered drawn to scale as some features may be exaggerated in order to more clearly illustrate certain features.

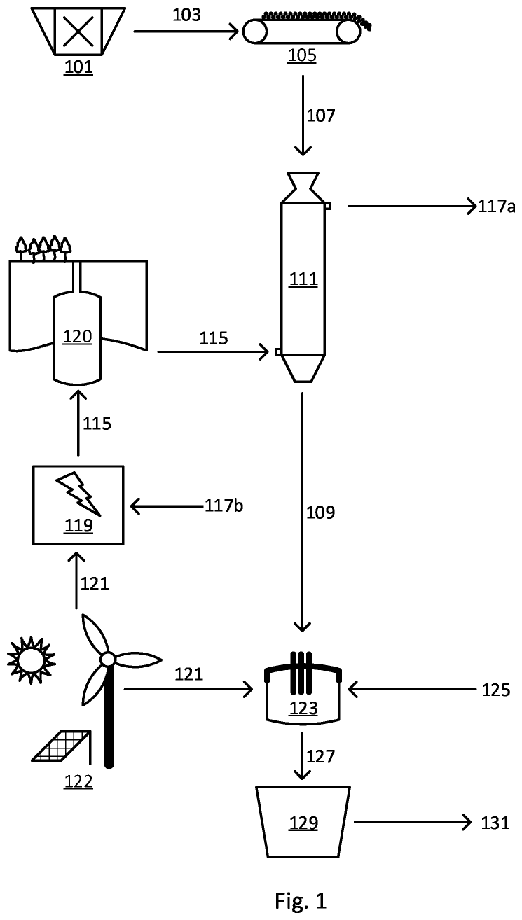

FIG. 1 schematically illustrates an iron ore-based steelmaking value chain according to the Hybrit concept. The iron ore-based steelmaking value chain starts at the iron ore mine 101. After mining, iron ore 103 is concentrated and processed in a pelletizing plant 105, and iron ore pellets 107 are produced. These pellets, together with any lump ore used in the process, are converted to sponge iron 109 by reduction in a direct reduction shaft 111 using hydrogen gas 115 as the main reductant and producing water 117a as the main by-product. The sponge iron 109 may optionally be carburized, either in the direct reduction shaft 111, or in a separate carburization reactor (not illustrated). The hydrogen gas 115 is produced by electrolysis of water 117b in an electrolyser 119 using electricity 121 that is preferably primarily derived from fossil-free or renewable sources 122. The hydrogen gas 115 may be stored in a hydrogen storage 120 prior to introduction into the direct reduction shaft 111. The sponge iron 109 is melted using an electric arc furnace 123, optionally together with a proportion of scrap iron 125 or other iron source, to provide a melt 127. The melt 127 is subjected to further downstream secondary metallurgical processes 129, and steel 131 is produced. It is intended that the entire value-chain, from ore to steel may be fossil-free and produce only low or zero carbon emissions.

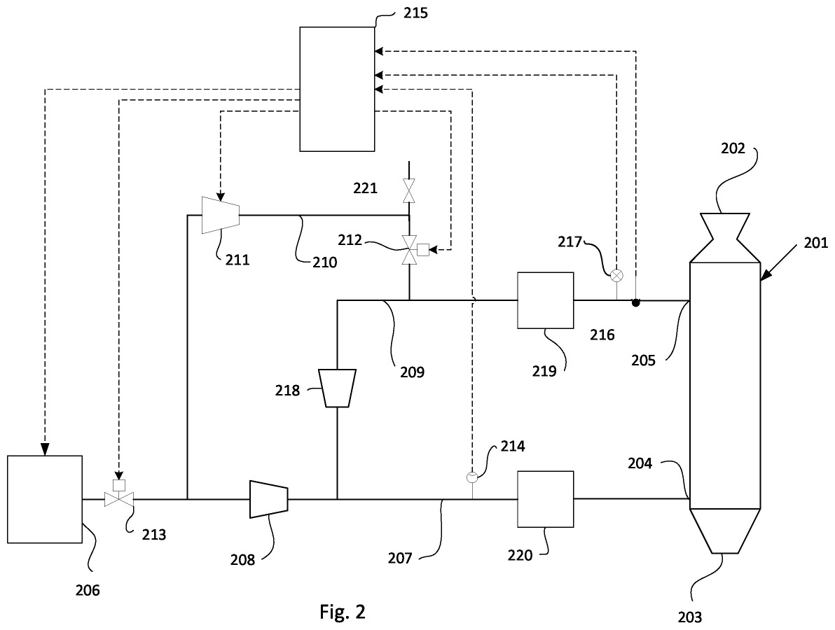

FIG. 2 schematically illustrates an exemplifying embodiment of a system suitable for performing the process as disclosed herein.

The system presented in FIG. 2 comprises a direct reduction (DR) shaft 201. The DR shaft comprises a first inlet 202 for introduction of iron ore into the DR shaft and a first outlet 203 for removal of sponge iron from the DR shaft. The DR shaft 201 further comprises a plurality of second inlets 204 for introduction of a reduction gas into the shaft, and at least one second outlet 205 for removal of top gas from the DR shaft. It should be understood that the second inlets 204 may be numerous, but that, for the sake of simplicity, only one thereof is shown in the figure.

The system further comprises a reduction gas source 206, connected through a gas line 207 with the reduction gas inlet(s) 204. The reduction gas source 206 may comprise a hydrogen production unit, typically a hydrogen production unit comprising a water electrolyser unit. The reduction gas from the reduction gas source may therefore contain almost exclusively hydrogen gas. The reduction gas from the reduction gas source 206 has a rather low pressure, in the order of 1.25 bar, and needs to be compressed before being introduced into the DR shaft 201. The pressure in the DR shaft will be in the region 8-10 bar during operation of the DR shaft. Therefore, the system further comprises a first compressor 208 provided in the gas line 207, configured to increase the pressure of the reduction gas to about 8 bar. For simplicity reasons, only one compressor 208 is indicated in the drawing. However, it should be understood that said compressor may be comprised by a plurality of compressors in series, if considered advantageous.

The system further comprises a primary circuit 209 for conducting at least a part of the top gas through it. The primary circuit 209 is connected in one end with the second gas outlet 205 and in another end with said gas line 207 downstream said first compressor 208.

There is also provided a secondary circuit 210 for conducting at least a portion of gas removed from gas conducted through the primary circuit 209. The secondary circuit 210 is connected in one end to the primary circuit 209 and in another end to said gas line 207 upstream the first compressor 208. The secondary circuit 210 further comprises means 211 therein for reducing the pressure of said portion of gas conducted through the secondary circuit 210, and a first valve 212 for controlling a flow of said portion of gas into the secondary circuit 210. In the embodiment shown, the means 211 for reducing the pressure in the secondary circuit 210 comprises a pressure reducer, from which energy is transferred from the gas into motion and further to electric power that may be recycled into the system, such as for the operation of electrolysers in the hydrogen gas source 206. In the secondary circuit 210 there is also provided vent valve 221, which is preferably a relief valve to be used for venting of gas in case of emergency, for example if the pressure reducer stops functioning and there is a pressure build up in the secondary circuit 210. There may also be provided a further controllable valve (not shown) for controlled vent of the secondary circuit 210.

The secondary circuit 210 will enable control of the pressure in the primary circuit 209 without flaring excessive top gas containing expensive hydrogen gas from the system. The secondary circuit 210 will function as a buffer, and will make it possible to decrease the amount of reduction gas conducted from the reduction gas source into the gas line 207.

The system further comprises a control arrangement for controlling a flow of reduction gas from the reduction gas source into the gas line 207. In the case in which the reduction gas source 206 comprises a water hydrolyser, such a control system comprises a control unit 215 configured to control the output of the water hydrolyser. In a case in which the reduction gas source 206 comprises a hydrogen gas storage or a hydrogen gas pipeline from which hydrogen gas is taken, the control arrangement comprises a second valve 213 for controlling a flow of reduction gas from the reduction gas source 206 into the gas line 207. In both cases, the system should comprise a gas flow rate meter 214 for measuring a flow of gas through the gas line 207, and a control unit 215, which is configured either to control the hydrolyser or to control said second valve 213 on basis of input from the gas flow rate meter 214. The gas flow rate meter 214 is arranged downstream the point at which the primary circuit 209 is connected to the gas line 207. If control is made by control of only the output of the hydrolyser, the second valve 213 may be excluded.

The control arrangement also comprises a temperature sensor 216 for measuring a temperature indicative of the temperature inside or at the outlet of the DR shaft 201. The temperature in the DR shaft is indicative of how the reduction of the iron ore proceeds. Accordingly, a non-complete reduction due to lack of reduction gas will result in a lowering of the temperature inside the DR shaft, thereby revealing such deficiency, and is therefore used as input to the control unit 215. On basis of the temperature input, the control unit 215 is thus configured to control the gas flow rate from the hydrogen gas source into the gas line 207, and to increase the flow rate as a response to the temperature being below a predetermined level.

The temperature sensor 216 may be arranged inside the DR shaft, or, for example, in the gas outlet 205, where the top gas exiting the DR shaft can be assumed to have a temperature indicative of the temperature inside the DR shaft 201.

The first valve 212 is a controllable valve, and the system further comprises a pressure sensor 217 arranged in the primary circuit 209. The control unit 215 is configured to control said controllable first valve 212 on basis of input received from the pressure sensor 217. The primary circuit 209 comprises a second compressor 218 provided at a point along the primary circuit 209 at which the secondary circuit 210 is connected to the primary circuit 209, and the pressure sensor 217 is positioned upstream said second compressor 218. The control unit 215 is configured to open the first valve 212 as a response to the pressure in the primary circuit 209 being above a predetermined level. As an alternative, the first valve may be a relief valve, set to automatically open when the pressure in the primary circuit 209 goes above said predetermined level. The means 211 for reducing the gas pressure in the secondary circuit is designed to reduce the pressure down to a pressure slightly above the gas pressure in the gas line 207 upstream the first compressor 208, for example down to a pressure of approximately 1.5 bar.

The primary circuit 209 further comprises a device 219 for a treatment of the top gas, said device 219 comprising a device (not shown in detail) for separation of an inert gas from the part of the top gas that is to be conducted through the primary circuit 209. The treatment device 219 also comprises a device (not shown in detail) for separation of water and dust from said part of the top gas that is to be conducted through the primary circuit 209. The treatment device 219 also comprises a heat exchanger (not shown in detail) for heat exchange between the top gas and the reduction gas flowing through the gas line 207. There may also be provided one or more separate heaters 220 for the heating of the reduction gas in the gas line 207.

The system described hereinabove with reference to FIG. 2 enables recycling of hydrogen gas instead of flaring thereof in cases of pressure build up in the primary circuit. The control unit 215 is configured to control the flow of reduction gas from the reduction gas source 206 into the gas line 207 on basis on input from the disclosed sensors. In the case of the reduction gas source 206 being a water electrolyser, the control unit 215 may be configured to control the output of the electrolyser on basis of input from said sensors, and in order to efficiently take advantage of the recycling of reduction gas via the secondary circuit 210.

1. A process for the production of sponge iron from iron ore, the process comprising the steps of:
charging iron ore into a direct reduction shaft;
introducing a hydrogen-rich reduction gas from a reduction gas source into the direct reduction shaft in order to reduce the iron ore and produce sponge iron;
removing a top gas from the direct reduction shaft, said top gas comprising unreacted hydrogen gas;
conducting in a primary circuit at least a part of the removed top gas and mixing said part with reduction gas from the reduction gas source at a point downstream of a first compressor provided in a gas line leading from the reduction gas source to the direct reduction shaft, and introducing the mixture into the direct reduction shaft; and
removing from said primary circuit a portion of the gas conducted therein, and conducting said portion of gas through a secondary circuit while reducing the pressure of said portion of gas, and mixing said portion of gas with reduction gas from the reduction gas source at a point in said gas line upstream of said first compressor.

2. The process according to claim 1, wherein a gas flow rate through the gas line and into the direct reduction shaft is measured, and a flow of reduction gas from the reduction gas source into the gas line is controlled on basis of the gas flow rate measured in the gas line.

3. The process according to claim 1, wherein the removal of said portion of gas from the primary circuit to the secondary circuit is dependent on the gas pressure in the primary circuit.

4. The process according to claim 1, further comprising the steps of: measuring the gas pressure in the primary circuit; and conducting said portion of gas into the secondary circuit from the primary circuit as a response to the measured pressure being at or above a predetermined first level.

5. The process according to claim 3, wherein the pressure in the primary circuit is regulated by means of removal of said portion of gas to the secondary circuit, in order not to exceed said predetermined first level.

6. The process according to claim 4, wherein the primary circuit comprises a second compressor provided downstream of a point along the primary circuit at which said portion of gas is removed to the secondary circuit, and wherein said measurement of the gas pressure is performed upstream of said second compressor.

7. The process according to claim 1, wherein the gas pressure in the secondary circuit is reduced to a predetermined second level, which is above a gas pressure level in said gas line upstream said first compressor.

8. The process according to claim 1, wherein the top gas is subjected to a gas treatment step at a point along the first primary circuit between a point where the top gas is removed from the direct reduction shaft and the point at which said portion of gas is conducted into the secondary circuit.

9. The process according to claim 8, wherein said treatment step comprises separation of an inert gas from said part of the top gas that is to be conducted through the primary circuit.

10. The process according to claim 8, wherein said treatment step comprises separating water from said part of the top gas that is to be conducted through the primary circuit.

11. The process according to claim 8, wherein said treatment step comprises reducing the temperature of the top gas in a heat exchanger and using said heat from the top gas for heating another gas to be used in said process.

12. The process according to claim 11, wherein said other gas is reduction gas which is to be introduced into the direct reduction shaft via said gas line.

13. A system for the production of sponge iron, the system comprising:
a direct reduction shaft comprising
a first inlet for introduction of iron ore into the shaft;
a first outlet for removing sponge iron from the shaft;
a second inlet for introduction of a reduction gas into the shaft, and
a second outlet for removal of top gas from the shaft;
a reduction gas source connected through a gas line with the reduction gas inlet;
a first compressor provided in said gas line;
a primary circuit for conducting at least a part of the top gas therethrough, said primary circuit being connected in one end with the second outlet and in another end with said gas line downstream of said first compressor,
a secondary circuit for conducting at least a portion of gas removed from gas conducted through the primary circuit, said secondary circuit being connected in one end to the primary circuit and in another end to said gas line upstream of said first compressor, and comprising means therein for reducing the pressure of said portion of gas conducted through the secondary circuit, and
a first valve for controlling a flow of said portion of gas into the secondary circuit.

14. The system according to claim 13, further comprising a control arrangement for controlling a flow of reduction gas from the reduction gas source into the gas line on basis of the gas flow rate in the gas line.

15. The system according to claim 14, wherein said control arrangement comprises a second valve for controlling a flow of reduction gas from the reduction gas source into the gas line, a gas flow rate meter for measuring a flow of gas through the gas line, and a control unit, which is configured to control said second valve on basis of input from the gas flow rate meter.

16. The system according to claim 13, wherein said first valve is configured to open for passage of gas into the secondary circuit as a response to the gas pressure in the primary circuit being above a predetermined level.

17. The system according to claim 13, wherein said first valve is a controllable valve, and wherein the system further comprises a pressure sensor arranged in the primary circuit and a control unit configured to control said controllable first valve on basis of input received from the pressure sensor.

18. The system according to any claim 17, wherein the primary circuit comprises a second compressor provided downstream of a point along the primary circuit at which the secondary circuit is connected to the primary circuit, and wherein the pressure sensor is positioned upstream of said second compressor.

19. The system according to claim 13, wherein the primary circuit comprises a device for treatment of the top gas, said device comprising a device for separation of an inert gas from said part of the top gas that is to be conducted through the primary circuit.

20. The system according to claim 13, wherein the primary circuit comprises a device for treatment of the top gas, said device comprising a device for separation of water from said part of the top gas that is to be conducted through the primary circuit.

21. The system according to claim 13, wherein the primary circuit comprises a device for treatment of the top gas, said device comprising a heat exchanger.

22. The system according to claim 21, wherein the heat exchanger is also connected to said gas line and configured to transfer heat from the top gas to the reduction gas to be introduced into the direct reduction shaft.

23. The system according to claim 13, wherein the reduction gas source comprises a water electrolyser unit.
